(19) United States
(12) Patent Application Publication
(10) Pub. No.: US 2002/0151313 A1
(43) Pub. Date: Oct. 17, 2002

(54) System and method for providing location information concerning wireless handsets via the internet

(76) Inventor: Graham Stead, Arlington, VA (US)

Correspondence Address: ROBERTS ABOKHAIR & MARDULA, SUITE 1000, 11800 SUNRISE VALLEY DRIVE, RESTON, VA, 20191, US

(21) Appl. No.: 10/076,814

(22) Filed: Feb. 15, 2002

Related U.S. Application Data
(60) Provisional application No. 60/268,977, filed on Feb. 15, 2001.

(51) Int. Cl. H04Q 7/20

(52) U.S. Cl. 455/456; 455/433

(57) ABSTRACT

Wireless network signal strength drive test data is translated into Geographic Markup Language (GML) shape information indicative of probable location of a handset served by the wireless network. Based on empirical drive test data, geographic shape data is generated for each of the plural sectors of the wireless network. In the event that one or more sector parameters are changed according to a network performance modeling algorithm, the generated geographic shape data for each of the plural sectors of the wireless network is modified. The Home Location Register (HLR) of the wireless network provides a sector ID corresponding to an identified sector of the wireless network serving a particular wireless handset. When a request including a sector ID corresponding to the identified sector serving the wireless handset is received, the geographic shape data for the identified sector is transformed into probabilistic shape information indicative of the probable location of the wireless. The probabilistic shape information is transmitted in response to the received request.

### CROSS-REFERENCE TO RELATED APPLICATION

This application claims the benefit of provisional application no. 60/268,977, filed Feb. 15, 2001. The 60/268,977 application is incorporated herein by reference, in its entirety, for all purposes.

### INTRODUCTION

The present invention relates generally to the field of wireless telephony. More particularly, the present invention relates to translation of wireless network signal strength data into shape information indicative of probable location of a handset served by the wireless network.

### BACKGROUND OF THE INVENTION

Over the last twenty years mobile telephones have gone from a mere novelty to a fact of life. The analog cellular telephones that were once toys for the rich and tools for high-powered salesmen are now digital personal communication system telephones that are tools-of-convenience for many families and even popular accessories for school children.

The mobile nature of all these new wireless telephones throws into doubt the location from which a telephone call is originating. For both public safety and commercial reasons, it is often useful to know this location information. However cellular telephone systems as originally implemented provided little if any information on location of a given wireless handset. The Federal Communications Commission (FCC) has promulgated regulations requiring wireless service providers to develop location determining infrastructures for the handsets using their systems. These regulations require enhanced location resolution in the years to come. To meet these public safety, commercial, and regulatory needs, various location technologies have been developed, or at least proposed.

The simplest wireless location technology known is the switch-based location method. This method is widely available to wireless operators; every wireless operator has it at this time. Although it is universally available, it is not very effective because it has a rather poor resolution. Switch-based location simply determines which particular mobile switching center a given handset is being serviced by. Since each mobile switching center usually services a large geographic area, this does not narrow down the location of a given handset very much. For example, a small city may be serviced by a single mobile switching center or may even share a mobile switching center with another nearby small city. More populous metropolitan areas may be served by three to half a dozen mobile switching centers, however this does not narrow down the location very much. Thus, switch-based location provides only crude resolution on the order of which city the handset is in.

Another location technology that has been developed is sector-based location. Sector-based locations narrow down the location of a given handset to which particular sector of a particular cell site is servicing the handset. This provides a resolution of about one to three square miles. Although not universally available to all wireless service providers, a significant number of the wireless service providers in United States do have this technology in many of the areas they service.

It has been proposed to enhance the location ability of wireless systems by using external Positioned Determining Equipment (PDE) to better determine position of the given handset based on the signals that are available in a wireless network. Specifically, the external PDE would be coupled to the wireless providers network management equipment to analyze data indicative of angle of arrival (AOA) or time difference of arrival (TDOA) for a particular handset with respect to its nearest sectors (the sector it is being serviced by, as well as adjacent sectors). It is believed that this technology will provide a resolution of approximately 100 meters. External PDE technology is not available to any wireless service providers at this time on anything other than an experimental basis, and the technology remains in a developmental stage.

It has also been proposed to provide location information using handset-based geographical positioning system (GPS) technology. This technology entails the addition of GPS receiver circuitry into each handset being serviced by the wireless network. Each handset received GPS information from GPS satellites and either conducts GPS location calculations within the handset, or transmits the received GPS data to a central facility on the wireless network for performing such calculations. This technology promises a resolution of location of the handset of less than 50 meters. Currently, this technology is not available for use by any wireless service providers.

Thus, we see that the technologies that are readily available to wireless network companies have only crude resolution. The technologies that promise improved resolution are not yet available and will have substantial disadvantages even once they are made commercially available. The external PDE technology will require the wireless network host to purchase additional expensive equipment to perform the AOA and TDOA calculations for the handsets to be located. The handset-based GPS technology would actually require that all the handsets serviced by the wireless network be swapped out for new handsets containing the new GPS receiver circuitry. This, for obvious reasons, presents a substantial inherent barrier to adoption of such a system even if it were technically feasible.

An additional disadvantage of all the prior art systems is that none of them provides location information in a format that is at all useful for commercial purposes. The crude resolution systems do not provide location information to commercial entities, much less putting such information in a form that could even be potentially useful. The more advanced, higher resolution, technologies such as external PDE and handset-based GPS have the obvious disadvantages that they are unavailable at this time and will not likely become available in any widespread form any time soon.

Thus, a system would be very useful that provides wireless handset location information in a format that would be useful to commercial entities.

### SUMMARY OF THE INVENTION

It is an object of the present invention to provide location information concerning wireless telephones in a form that is commercially useful.

It is another object of the present invention to develop shape information concerning sector in a wireless network and converting that shape information into a geographic descriptive language.

Wireless network signal strength drive test data is translated into Geographic Markup Language (GML) shape information indicative of probable location of a handset served by the wireless network. Based on empirical drive test data, geographic shape data is generated for each of the plural sectors of the wireless network. In the event that one or more sector parameters are changed according to a network performance modeling algorithm, the generated geographic shape data for each of the plural sectors of the wireless network is modified. The Home Location Register (HLR) of the wireless network provides a sector ID corresponding to an identified sector of the wireless network serving a particular wireless handset. When a request including a sector ID corresponding to the identified sector serving the wireless handset is received, the geographic shape data for the identified sector is transformed into probabilistic shape information indicative of the probable location of the wireless. The probabilistic shape information is transmitted in response to the received request.

### BRIEF DESCRIPTION OF THE DRAWINGS

Additional objects and advantages of the present invention will be apparent in the following detailed description read in conjunction with the accompanying drawing figures.

FIG. 1 illustrates a conceptual view of signal flow of location data and point-of-interest information between a wireless network and entities communicating the Internet.

FIG. 2 illustrates a block diagram view of system architecture and signal flow according to a first embodiment of the present invention.

FIG. 3 illustrates a block diagram view of system architecture and signal flow according to a second embodiment of the present invention.

FIG. 4 illustrates a flow chart of an algorithm for practicing the method according to the present invention.

FIG. 5 illustrates elimination of adjacent edges to form a single polygon according to an algorithm aspect of the present invention.

FIG. 6 illustrates a polygon that has been formed with enclosed spaces according to an algorithm aspect of the present invention.

FIG. 7 illustrates elimination of enclosed spaces by forming two polygons according to an algorithm aspect of the present invention.

FIG. 8 illustrates a conceptual view of a set of probability contours associated with a particular sector of a wireless network.

### DETAILED DESCRIPTION OF THE VARIOUS EMBODIMENTS

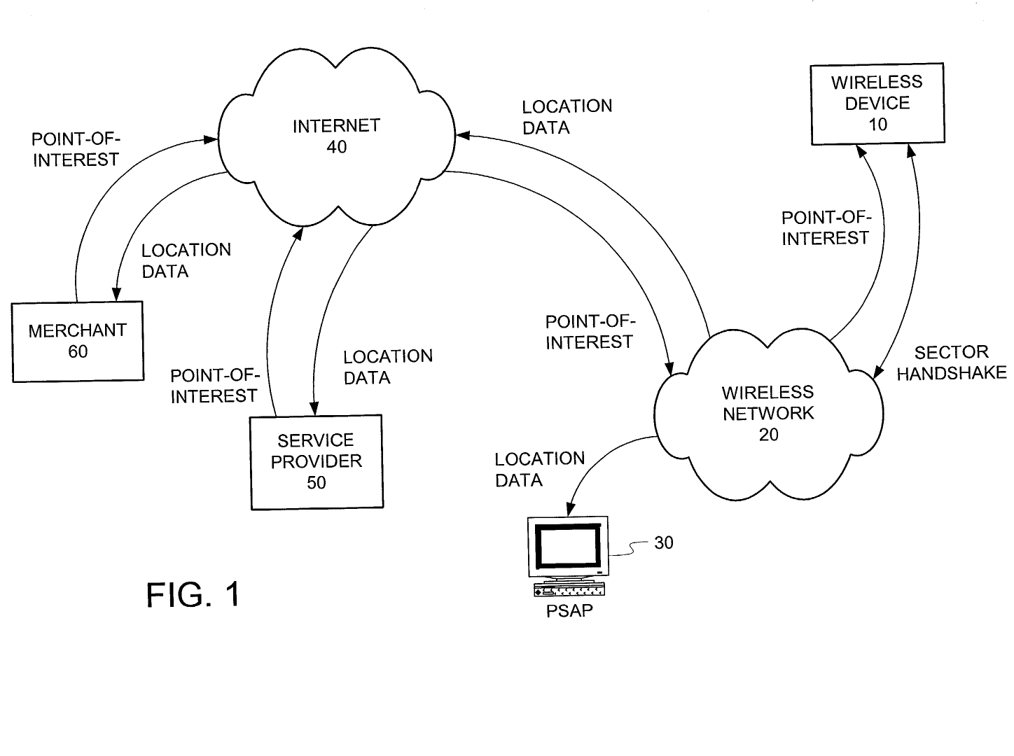

Referring to FIG. 1, the general flow of location data and point-of-interest information is illustrated conceptually. Location data concerning a wireless device 10 is generated within the wireless network 20 based on which sector of the wireless network 20 is servicing the wireless device 10 via sector handshaking. The wireless network 20 provides location data both to commercial entities via a global interconnected network of networks 40 (for example, the Internet) and to a Public Safety Access Point (PSAP) 30. The trading of location data for point-of-interest information may be conducted according to a sub describer-initiated mode of operation, or according to a merchant-initiated mode of operation.

Subscriber-initiated commerce is conducted wherein the user of the wireless device 10 deliberately seeks out information and causes location data concerning the wireless device 10 to be provided to commercial entities, such as a merchant 60 or a service provider 50. Based on the location data received from the wireless network 20, the merchant 60 or the service provider 50 responds by sending point-of-interest information back through the network 40 and the wireless network 20 to the wireless device 10. This mode of operation is useful in the event the user of the wireless device 10 would like to know the location of the nearest automatic teller machine, or the nearest Mexican restaurant, the nearest Staples store, or any other location-based information. All of these inquiries may be satisfactorily answered by providing location data to the relevant service provider 50 or merchant 60 who may then respond with an answer to the geographic proximity question with point-of-interest information.

Merchant-initiated commerce, on the other hand, relies upon a regular stream of location data being provided from the wireless network 20 to the commercial entities via the network 40. It is useful for the service provider 50 or the merchant 60 to receive location data indicating when the wireless device 10 is physically proximate to their respective places of business. For example, if the wireless device is in the vicinity of the merchant 60, location data indicating this will give the merchant 60 a timely opportunity to transmit an advertisement, or an electronic coupon as point-of-interest data to the wireless device 10. Thus, the user of wireless device 10 becomes a commercial target-of-opportunity for making a sale while they happen to be in the neighborhood.

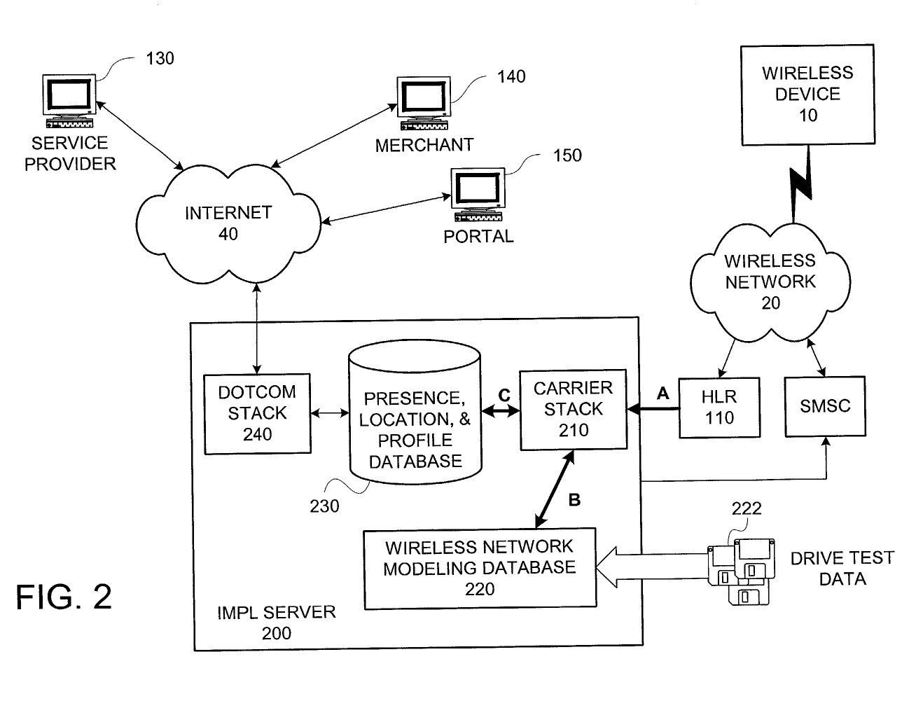

Referring to FIG. 2, system architecture and operation according to a first embodiment of the present invention are illustrated. A home location register 110 maintains an immediately current index of which sector of the wireless network 20 is servicing the wireless device 10. An Instant Messaging Presence and Location (IMPL) server 200 is connected so as to receive information from the HLR 110 concerning sector ID information for wireless devices on the wireless network 20. The IMPL server 200 is connected between the HLR 110 of the wireless network 20 and the network 40 so as to provide a communications link between users of the network 40 and users of the wireless network 20. Detailed explanation concerning the operation and architecture of an IMPL server 200 for use by the present invention is disclosed in co-pending U.S. patent application Ser. No. 09/771,201, filed Jan. 26, 2001, which is incorporated by reference herein, in its entirety, for all purposes.

The IMPL server 200 contains a database software module 230 concerning presence, location, and profile information for the various wireless devices on the wireless network 20. A carrier stack software module 210 provides for orderly updating and use of information into and out of the database 230 with respect to the wireless network 20. An Internet stack software module 240 provides for orderly accessing of presence location information from the database 230 by commercial entities 130, 140, 150 connected to the network 40.

A wireless network modeling database 220 is provided at the IMPL server 200 as a software module that models the sector by sector performance of the wireless network 20. Performance modeling by the database 220 is based primarily on drive test data 222 that is updated on a continuous basis by the operator of the wireless network 20. The wireless network modeling database 220 has the capability of portraying graphically not only the drive test-based performance information for sectors of the wireless network 20, but additionally, to predict performance changes based on hypothetical parameter modifications of the wireless network 20. For example, the performance modeling database 220 is capable of showing modified performance for network sectors based on changes in antenna height, antenna azimuth, antenna type, frequency plan and color code, antenna location, terrain height, and antenna down tilt. Particularities of architecture and operation of the wireless network-modeling database 220 are disclosed in detail in co-pending U.S. patent application Ser. No. 09/462,201, filed Aug. 21, 2000, which is incorporated by reference herein, in its entirety, for all purposes.

Whenever new drive test data 222 is provided to database 220, or when modeling is performed based on parameter changes in the database 220, the performance of each of the sectors of the wireless network 220 is modeled. Location information to be used according to the present invention is based on this sector performance information in the wireless network modeling database 220.

Conceptually, the carrier stack 210, the wireless network modeling database 220, the presence, location, and profile database 230, and the Internet stack 240 may be viewed as separate software modules all running on a common IMPL server 200. Of course, as would be understood by those of ordinary skill in the art, any of these software modules may be implemented on a separate server in communication with the software modules running on the IMPL server 200. In fact, the IMPL server 200 may, in the alternative, be configured as a thin client and all of the software processes represented by the illustrated software modules 210, 220, 230, 240 are remotely provided by an application service provider (ASP).

According to a mode of operation according to the first embodiment of the present invention, sector identification information concerning a particular handset is provided from the HLR 110 to the carrier stack 210 (step A). The carrier stack 210 then sends the sector identification information (step B) to the wireless network modeling database 220 which then returns to the carrier stack 210 geographic shape data indicative of location. The carrier stack 210 then provides the location data (in the form of geographical shape data) concerning the particular handset to the database 230 (step C) for subsequent retrieval by interested parties 130, 140, 150 on the network 40.

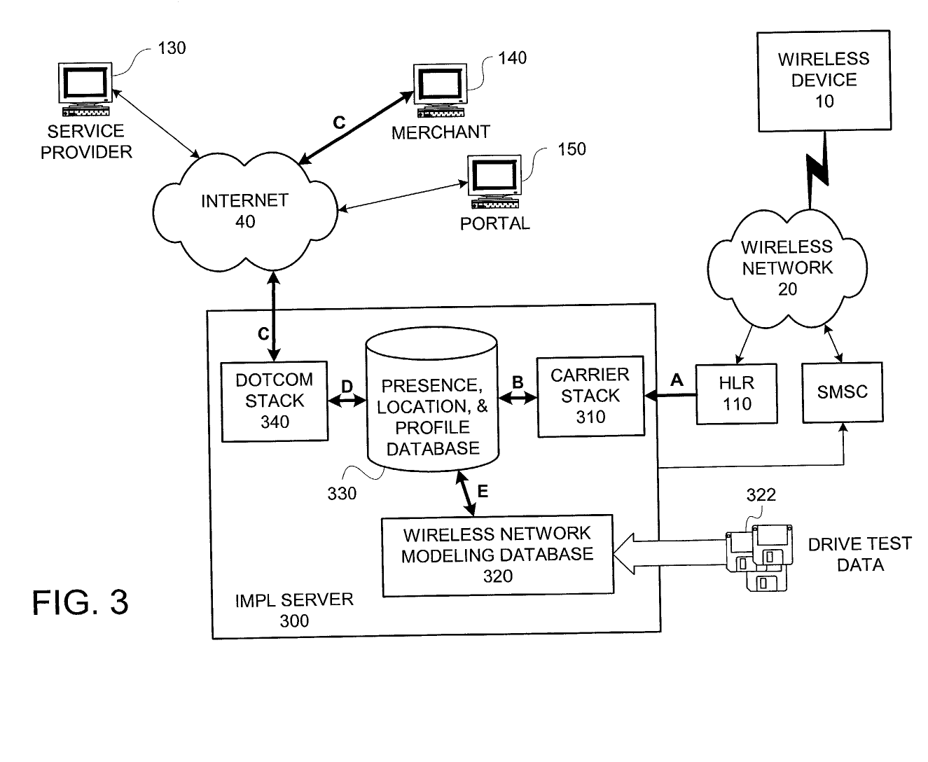

Referring to FIG. 3, an architecture and operational flow according a second embodiment of the present invention is illustrated. Sector identification information corresponding to the wireless device 110 is supplied by the HLR 110 to the carrier stack 310 (step A). The carrier stack 310 then forwards the sector ID to the presence, location, and profile database 330 (step B). According to this mode of operation of the second embodiment, the sector ID information is warehoused in the database 330 and is converted into location information only on the initiative of some entity exterior to the IMPL server 300. For example, a merchant 140 (or equivalently, a service provider 130 or a portal 150) initiates further processing by sending a request via the network 40 to the Internet stack 340 of the IMPL server 300 (step C). The Internet stack 340 then passes the request on to the presence, location, and profile database 330 (step D). Upon receiving the initiating message from the Internet stack 340, the profile database 330 sends a request, accompanied by the sector ID information to the wireless network database 320 (step E).

Upon receiving the request accompanied by a sector ID, the modeling database 320 calculates location information (in the form of geographic shape data) and returns that information to the profile database 330 (step E). The profile database 330 then returns to the initiating merchant 140 the requested location information via the network 40.

As an alternative mode of operation, the generation of location information may be initiated by the user of the wireless device 10 and then sent to a commercial entity of its choice selected from, for example, a service provider 130, a merchant 140 or a portal 150.

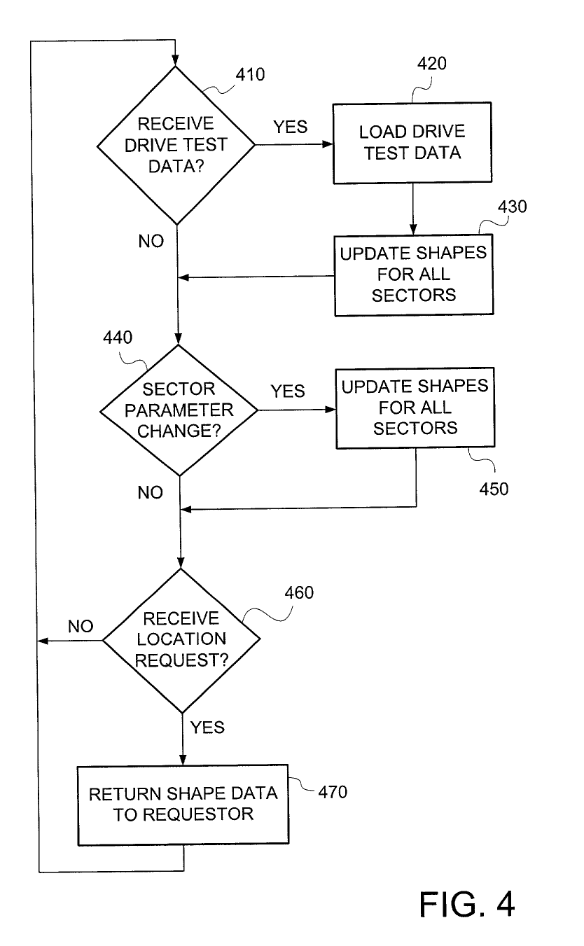

Referring to FIG. 4, a flow chart for an operational algorithm of a wireless network modeling database according to the present invention is illustrated. In the event that new drive test data is received at the modeling database 410, the new drive test data is loaded 420 and geographic shape data is updated for all sectors of the wireless network 430. Additionally, in the event that one or more sector parameters are changed 440, geographic shape data for each of the sectors is further updated 450.

If a location request has been received at the modeling database 460, then shape data concerning the sector ID corresponding to the location of the wireless device in question is returned to the requester 470. Otherwise, the algorithm continues to await new drive test data or new sector parameter changes or any further location requests being received.

One aspect of the present invention is the creation of location data in the form of geographic shape information based on a sector ID value. This is a two-step process. The first step is the deriving of one or more shapes that represent location probability for a handset that is being serviced by a given sector of the wireless network based on drive test data for that sector. The second step is translation of this shape information (the one or more shapes) into shape data that is understandable according to a geographic descriptive language. A geographic language useful for practicing the present invention is, for example, the Geographic Markup Language (GML), or alternatively, a vector description of the contours of the shape.

A shape algorithm is used to turn empirical data into shapes. The input to the algorithm is a series of RF measurements. Each RF measurement contains at least three pieces of information:

1. received signal strength (in dBm)

2. a cell/sector identifier

3. a location (latitude, longitude, in degrees)

RF measurement equipment provides the first and third pieces of information. The second piece of information may be conveniently provided by network performance modeling software that uses an algorithm to determine the most likely sector to have transmitted the signal that was measured.

The output of the shape algorithm is a polygon associated with each Sector in the wireless network. The polygon represents a contour within which a mobile device is likely to be located. It is not required that there be only a single contour for each cell/sector, because the sector coverage area could be discontinuous. In the case discontinuous sector coverage, there would naturally be multiple contours for an area in which the mobile device is likely to be located. For example, sectors may map to polygons as follows:

| Sector Id | Contours |
|---|---|
| 1 | Contour #1 description |
| 2 | Contour #2 description |
| | Contour #3 description |

Contours can be output in any geographic modeling language. For example, GML 2.0 defines a Polygon and a LinearRing object that could be used to describe the polygon. For Sector Ids that have multiple contours (e.g., Sector 2 above), GML 2.0 defines a MultiPolygon object. Alternatively, they are encoded as multiple LinearRings.

If the application requires a single point (e.g. latitude and longitude) instead of a polygon, this can easily be produced as a by-product of the polygon algorithm. To reduce the polygon(s) to a single point requires the straightforward calculation of the geographic average (centroid) of the above polygons:

| Sector Id | Centroid |
|---|---|
| 1 | Contour #1 centroid |
| 2 | Contour #2, Contour #3 |
| | centroid |

Determination of the polygon is performed using empirical data that is provided (as indicated above) as a series of measurements at different coordinates. The following steps are used to build a polygon:

The data is averaged geographically using an appropriate average bin size. This removes localized variations and normalizes the data.

The resulting bins are actually squares (a special polygon, but still a polygon). Each square has a signal strength and Sector Id associated with it. The binning algorithm is designed in such a way that adjacent bins/polygons share sides.

In order to create a polygon, the algorithm iterates through each bin, checking whether it contains any adjacent sides to other bins with the same Sector Id.

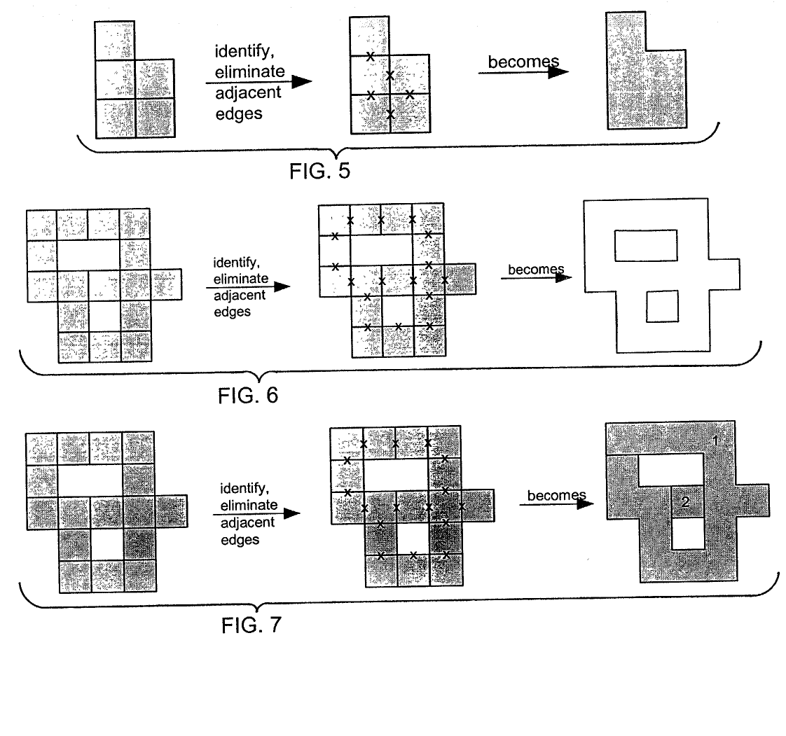

As adjacent sides are discovered, they are deleted, and the points that used to form separate polygons are merged into a single polygon. This is shown in FIG. 5.

Output GML text identifying the final polygon(s).

Depending on actual bin location, it is possible for this algorithm to produce “enclosed” spaces, as shown in FIG. 6. The enclosed spaces violate the original polygonal properties of the shape. In order to eliminate these enclosed spaces and preserve the polygons, the algorithm is modified to check, each time two shapes are collapsed into one, whether an enclosed space has been created. With this modification, the algorithm produces the distinct polygons 1, 2 as shown in FIG. 7.

Creation or updating of shape information concerning each of the sectors in the wireless network is done each time new drive test data is input, or whenever modeling is done according to a parameter change for one or more sectors of the network. For each sector, the shape data comprises one or more two-dimensional shape contours that indicate the probability of where a handset would be located assuming it were being serviced by that sector.

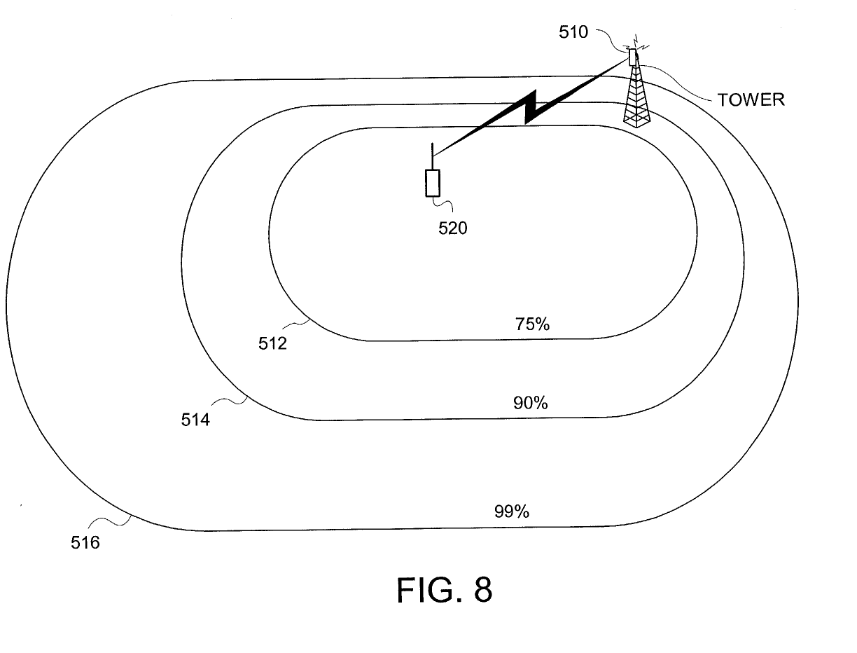

Referring to FIG. 8, a conceptual view of a set of probability contours associated with a particular sector of a wireless network is illustrated. The plural shapes illustrated indicate varying levels of probabilistic confidence in whether a handset 520 is located inside that given contour. For example the smallest shape 512 indicates a 75% confidence factor that the handset 520 being serviced by the identified sector 510 is located inside the contour of that shape. A second, larger shape 514 would indicate, say, a 90% confidence factor that the handset 520 being serviced by the identified sector 510 is located inside the contour of that shape. A third, still larger shape 516 indicates the boundaries of a region in which there is a 99% confidence factor that the handset 520 being serviced by that sector 510 is located.

The multiple shapes 512, 514, 516 corresponding to diverse confidence factors are useful to meet the needs of different information users. A commercial user may be satisfied with the 75% probability shape to indicate whether a handset is in the neighborhood of their establishment. On the other hand, public safety usage of the location information may require the best possible (i.e. 99% confidence factor) certainty as to the location of a handset. When a location information request is received at the wireless network modeling database, the database need not return all of the entire set of shapes of shape information corresponding to that sector. Rather, only the shape corresponding to the confidence factor required by the requester need be sent.

To provide the shape information in a useful format, the translation of the shape information into a geographic descriptive language (e.g., GML) is performed. This translation takes the shape data as updated in the modeling database from a graphical format into a GML coding that indicates position in space as well as shape and size. For example a GML coding of a piece of shape information may correspond to a circle having a specified position in space at its center and a particular radius. Also, the information may be in the form of an ellipse when coded in GML, indicating not only the location but the size of the major and minor axes and orientation thereof. GML may also be used to describe regular and irregular polygons as appropriate.

The present invention has been described in terms of preferred embodiments, however, it will be appreciated that various modifications and improvements may be made to the described embodiments without departing from the scope of the invention.

What is claimed is:

1. A method for generating location data concerning a wireless communication device being served by an identified sector of a wireless network, the method comprising:
generating geographic shape data for each of the plural sectors of the wireless network based on empirical drive test data;
modifying the generated geographic shape data for each of the plural sectors of the wireless network, in the event that one or more sector parameters are changed according to a network performance modeling algorithm;
receiving a request for location data concerning the wireless communication device, the request including a sector ID corresponding to the identified sector serving the wireless communication device;
transforming the geographic shape data for the identified sector into probabilistic shape information indicative of the probable location of the wireless communication device; and
transmitting the probabilistic shape information in response to the received request.

2. The method for generating location data of claim 1, wherein generating geographic shape data for each of the plural sectors of the wireless network comprises:
geographically averaging the empirical drive test data to provide bins, each bin having a signal strength and Sector Identifier;
iterating through each bin to check whether it contains any adjacent sides to other bins with the same Sector Identifier;
deleting adjacent sides between bins having the same Sector Identifier to merge the bins into a single polygon associated with that Sector Identifier;
producing text to identify the polygon formed by merging; and
repeating the steps of deleting and producing until one or more polygons have been generated for each of the plural sectors of the wireless network.
